(19) United States
(12) Patent Application Publication
(10) Pub. No.: US 2012/0105492 A1
(43) Pub. Date: May 3, 2012

(54) BACKLIGHT MODULE AND DRIVING CIRCUIT

(75) Inventor: Ming-Xian Li, Taoyuan County (TW)

(73) Assignee: CHUNGHWA PICTURE TUBES, LTD., Taoyuan (TW)

(21) Appl. No.: 12/982,801

(22) Filed: Dec. 30, 2010

(30) Foreign Application Priority Data
Nov. 2, 2010 (TW) 99137654

(51) Int. Cl. G09G 5/10; H05B 37/00; H05B 37/02

(52) U.S. Cl. 345/690; 315/185 R; 315/193

(57) ABSTRACT

A backlight module and a driving circuit are provided. The driving circuit includes a plurality of current sources and a current switching unit. The current sources provide a plurality of driving currents. The current switching unit is coupled between a plurality of light emitting element strings and the current sources for transmitting the driving currents to the light emitting element strings, and switching the driving currents received by the light emitting element strings by timing. Therefore, the brightness of the light emitting element strings can be equalized.

### CROSS-REFERENCE TO RELATED APPLICATION

This application claims the priority benefit of Taiwan application serial no. 99137654, filed on Nov. 2, 2010. The entirety of the above-mentioned patent application is hereby incorporated by reference herein and made a part of this specification.

### BACKGROUND

1. Field of the Invention

The invention relates to a backlight module and a driving circuit. Particularly, the invention relates to a light emitting diode backlight module and a driving circuit.

2. Description of Related Art

Since a light emitting diode (LED) has features of small size, low power consumption and long service life, etc., it is widely applied in various information products such as mobile phones, cameras and liquid crystal displays (LCDs), etc.

Taking the LCD as an example, the LEDs can be used as backlight sources of the LCD. When the LCD uses the LEDs as the backlight sources, a large amount of LEDs is required, so that a brightness of a displayed image may comply with user's requirement. Moreover, since the LCD uses a large amount of the LEDs, driving currents of the LEDs are increased and a number of driving circuits thereof is increased. Therefore, according to a design of the LED backlight source, a plurality of light emitting modules are coupled in parallel, and each of the light emitting modules includes a plurality of the LEDs. In this way, the driving currents of the LEDs can be reduced and the number of the driving circuits of the LEDs can be reduced.

Accordingly, when a backlight module using the LEDs as the backlight sources is driven, a plurality of the driving currents is provided to simultaneously drive a plurality of the light emitting modules. However, since electrical characteristics of each device are slightly different, magnitudes of the driving currents are different. Although the difference of the driving current can be mitigate through a feedback method, the driving currents are still slightly different, so that brightness of the light emitting modules cannot be totally the same.

### SUMMARY OF THE INVENTION

The invention is directed to a backlight module and a driving circuit thereof, which can equalize an average current flowing through each of light emitting element strings, so as to equalize a brightness of each of the light emitting element strings.

The invention provides a driving circuit adapted to drive a plurality of light emitting element strings. The driving circuit includes a plurality of current sources and a current switching unit. The current sources respectively provide a plurality of driving currents. The current switching unit is coupled to the light emitting element strings and the current sources for transmitting the driving currents to the light emitting element strings, and switching the driving currents received by the light emitting element strings by timing. Time for each of the light emitting element strings receiving the driving currents is the same.

The invention provides a backlight module including a plurality of light emitting element strings and a driving circuit. The driving circuit includes a plurality of current sources and a current switching unit. The current sources respectively provide a plurality of driving currents. The current switching unit is coupled to the light emitting element strings and the current sources for transmitting the driving currents to the light emitting element strings, and switching the driving currents received by the light emitting element strings by timing. Time for each of the light emitting element strings receiving the driving currents is the same.

In an embodiment of the invention, the current switching unit includes a plurality of first switch groups. Each of the first switch groups includes n first switches and n second switches, where n is a positive integer. First ends of the first switches are respectively coupled the corresponding light emitting element string. First ends of the second switches are respectively coupled to second ends of the first switches, and second ends of the second switches are respectively coupled to the corresponding current source. A second end of an i-th first switch of each of the first switch groups is coupled to a second end of an i-th first switch of the adjacent first switch group, where i is a positive integer and 1≦i≦n. One of the first switches and one of the second switches are turned on, and the turned on first switch and the turned on second switch are switched by timing. In different first switch groups, the turned on first switch and the turned on second switch correspond to different positions.

In an embodiment of the invention, a switching sequence of turning on the first switches is inversed to a switching sequence of turning on the second switches.

In an embodiment of the invention, the current switching unit includes a plurality of second switch groups. Each of the second switch groups includes a plurality of third switches. First ends of the third switches are respectively coupled to the corresponding light emitting element string, and second ends of the third switches are respectively coupled to the current sources. One of the third switches is turned on, and the turned on third switch is switched by timing. In different second switch groups, the turned on third switch is coupled to the different current source.

In an embodiment of the invention, the current switching unit includes a plurality of multiplexers. Each of the multiplexers has a plurality of input terminals and an output terminal. The output terminal of each of the multiplexers is coupled to the corresponding light emitting element string, and the input terminals of each of the multiplexers are respectively coupled to the current sources. Each of the multiplexers switches the selected current source by timing, and different multiplexers select different current sources.

In an embodiment of the invention, the backlight module further includes an adjustment unit, which is coupled to the light emitting element strings and the current sources for adjusting the driving currents according to currents of the light emitting element strings.

In an embodiment of the invention, the backlight module further includes a plurality of switches and a control unit. The switches are respectively coupled between the current sources and a ground voltage. The control unit is coupled to the switches, and controls conduction states of the switches according to a pulse width modulation signal, so as to control the current sources to whether or not provide the driving currents to the light emitting element strings.

In an embodiment of the invention, the control unit includes a buffer and a resistor. An input terminal of the buffer receives the pulse width modulation signal, and an output terminal of the buffer is coupled to the switches. The resistor is coupled between the input terminal of the buffer and the ground voltage.

In an embodiment of the invention, the light emitting element strings are light emitting diode strings.

According to the above descriptions, in the backlight module and the driving circuit of the invention, the current switching unit is used to sequentially switch the driving currents received by each of the light emitting element strings, so that the driving currents are alternately transmitted to each of the light emitting element strings. In this way, an average current of each of the light emitting element stings is the same, so that the light emitting brightness of the light emitting element strings are similar or the same.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a backlight module according to an embodiment of the invention.

FIG. 2 is a circuit schematic diagram of the current switching unit 111 of FIG. 1 according to an embodiment of the invention.

FIG. 3 is a circuit schematic diagram of the current switching unit 111 of FIG. 1 according to another embodiment of the invention.

FIG. 4 is circuit schematic diagram of the current switching unit 111 of FIG. 1 according to still another embodiment of the invention.

### DETAILED DESCRIPTION OF DISCLOSED EMBODIMENTS

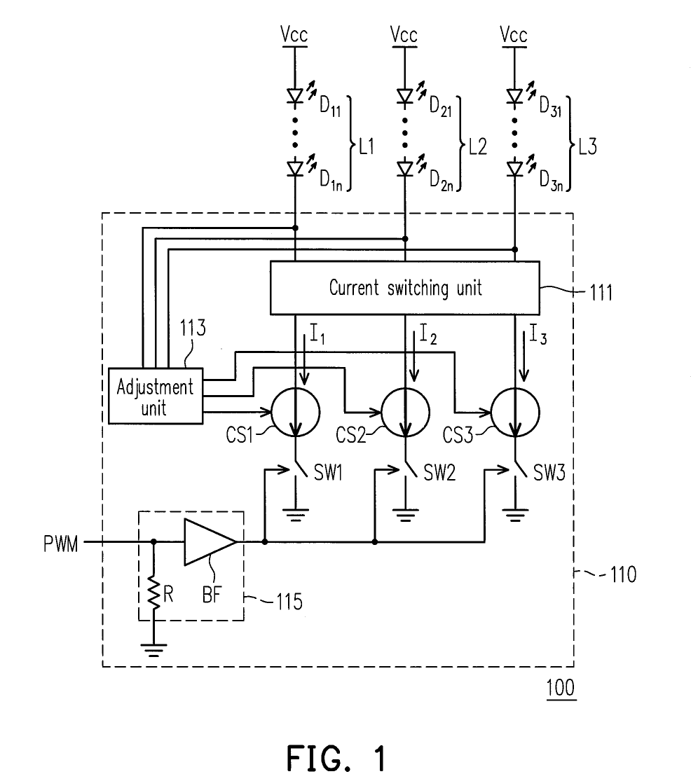

FIG. 1 is a schematic diagram of a backlight module according to an embodiment of the invention. Referring to FIG. 1, in the present embodiment, the backlight module 100 includes a plurality of light emitting element strings (three light emitting element strings L1-L3 are taken as an example) and a driving circuit 110. In the present embodiment, the light emitting element string L1 includes a plurality of light emitting diodes (LEDs) D₁₁-D₁ₙ connected in series, the light emitting element string L2 includes a plurality of LEDs D₂₁-D₂ₙ connected in series, and the light emitting element string L3 includes a plurality of LEDs D₃₁-D₃ₙ connected in series, where n is a positive integer. In FIG. 1, the light emitting element strings L1-L3 are coupled to a system voltage Vcc, though the light emitting element strings L1-L3 can also be coupled to a ground voltage according to different serial connecting methods of the LEDs, which is not limited by the invention.

In the present embodiment, the driving circuit 110 at least includes a current switching unit 111 and a plurality of current sources (three current sources CS1-CS3 are taken as an example). The current switching unit 111 is coupled to the light emitting element strings L1-L3 and the current sources CS1-CS3 for transmitting driving currents I₁-I₃ provided by the current sources CS1-CS3 to the light emitting element strings L1-L3, and switching the driving currents received by the light emitting element strings L1-L3 by timing. In other words, if a time interval is equally divided into a plurality of periods, in a first period, the current switching unit 111 transmits the driving current I₁ to the light emitting element string L1, transmits the driving current I₂ to the light emitting element string L2, and transmits the driving current I₃ to the light emitting element string L3. In a second period, the current switching unit 111 transmits the driving current I₁ to the light emitting element string L2, transmits the driving current I₂ to the light emitting element string L3, and transmits the driving current I₃ to the light emitting element string L1. In a third period, the current switching unit 111 transmits the driving current I₁ to the light emitting element string L3, transmits the driving current I₂ to the light emitting element string L1, and transmits the driving current I₃ to the light emitting element string L2. In a fourth period, operation of the current switching unit 111 is the same to that of the current switching unit 111 in the first period, which is not repeated, and the others are deduced by analogy.

Accordingly, each of the driving currents I₁-I₃ are respectively transmitted to the light emitting element strings L1-L3 in different periods, i.e. the driving currents I₁-I₃ are alternately transmitted to the light emitting element strings L1-L3. Taking the light emitting element string L1 as an example, time for the light emitting element string L1 receiving the driving currents I₁-I₃ is the same, so that an average current thereof is an average of the driving currents I₁-I₃, and average currents of the light emitting element strings L2-L3 are also the same. Therefore, since the average currents of the light emitting element strings L1-L3 are the same, light emitting brightness of the light emitting element strings L1-L3 are similar or the same.

Further, the driving circuit 110 further includes an adjustment unit 113, which is coupled to the light emitting element strings L1-L3 and the current sources CS1-CS3. The adjustment unit 113 can measure the currents of the light emitting element strings L1-L3, and adjusts magnitudes of the driving current I₁-I₃ according to the measured currents. In other words, assuming the light emitting element strings L1-L3 are set to 20 mA, if the current of the light emitting element string L1 is greater than 20 mA, the driving current I₁ is decreased, and if the current of the light emitting element string L1 is less than 20 mA, the driving current I₁ is increased. If the current of the light emitting element string L2 is greater than 20 mA, the driving current I₂ is decreased, and if the current of the light emitting element string L2 is less than 20 mA, the driving current I₂ is increased. If the current of the light emitting element string L3 is greater than 20 mA, the driving current I₃ is decreased, and if the current of the light emitting element string L3 is less than 20 mA, the driving current I₃ is increased.

Moreover, since the driving currents I₁-I₃ are alternately transmitted to the light emitting element strings L1-L3, if the driving current I₁ is transmitted to the light emitting element string L1, the magnitude of the driving current I₁ can be adjusted according to the current of the light emitting element string L1. If the driving current I₁ is transmitted to the light emitting element string L2, the magnitude of the driving current I₁ can be adjusted according to the current of the light emitting element string L2. If the driving current I₁ is transmitted to the light emitting element string L3, the magnitude of the driving current I₁ can be adjusted according to the current of the light emitting element string L3. Moreover, the current adjustment method can also be applied to the driving current I₂ and I₃, though the invention is not limited thereto.

Moreover, the driving circuit 110 may also include a control unit 115 and a plurality of switches (three switches SW1-SW3 are taken as an example). In the present embodiment, the switch SW1 is coupled between the current source CS1 and the ground voltage, the switch SW2 is coupled between the current source CS2 and the ground voltage, and the switch SW3 is coupled to the current source CS3 and the ground voltage. As shown in FIG. 1, in the present embodiment, the control unit 115 includes a buffer BF and a resistor R. An input terminal of the buffer BF receives a pulse width modulation signal PWM, and an output terminal of the buffer BF is coupled to the switches SW1-SW3. The resistor R is coupled between the input terminal of the buffer BF and the ground voltage. According to the above description, the switches SW1-SW3 are turned on/off in response to a voltage level of the pulse width modulation signal PWM, so that the control unit 115 may control the current sources CS1-CS3 to whether or not provide the driving currents I₁-I₃ to the light emitting element strings L1-L3 according to the pulse width modulation signal PWM.

It should be noticed that the switches SW1-SW3 can be implemented by devices capable of implementing switching operations such as transistors, etc., and the buffer BF can be implemented by an operation amplifier, though the invention is not limited thereto, and those skilled in the art can change the design or the applied devices by themselves.

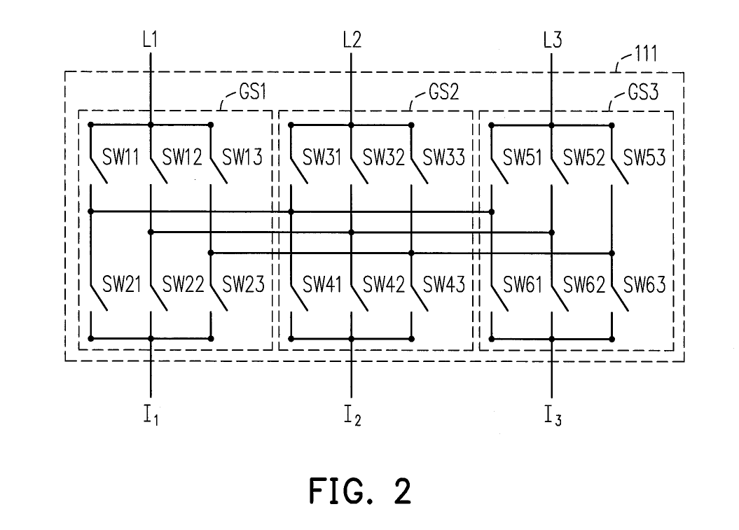

FIG. 2 is a circuit schematic diagram of the current switching unit 111 of FIG. 1 according to an embodiment of the invention. Referring to FIG. 2, in the present embodiment, the current switching unit 111 includes a plurality of switch groups (three switch groups GS1-GS3 are taken as an example). The switch group GS1 includes n first switches (n is a positive integer, and three switches SW11-SW13 are taken as an example) and n second switches (three switches SW21-SW23 are taken as an example). The switch group GS2 includes n first switches (three switches SW31-SW33 are taken as an example) and n second switches (three switches SW41-SW43 are taken as an example). The switch group GS3 includes n first switches (three switches SW51-SW53 are taken as an example) and n second switches (three switches SW61-SW63 are taken as an example), where n is a positive integer corresponding to a number of the light emitting element strings.

First ends of the switches SW11-SW13 are all coupled to the light emitting element string L1, second ends of the switches SW11-SW13 are respectively coupled to first ends of the switches SW21-SW23, and second ends of the switches SW21-SW23 are all coupled to the current source CS1 for receiving the driving current I₁. First ends of the switches SW31-SW33 are all coupled to the light emitting element string L2, second ends of the switches SW31-SW33 are respectively coupled to first ends of the switches SW41-SW43, and second ends of the switches SW41-SW43 are all coupled to the current source CS2 for receiving the driving current I₂. First ends of the switches SW51-SW53 are all coupled to the light emitting element string L3, second ends of the switches SW51-SW53 are respectively coupled to first ends of the switches SW61-SW63, and second ends of the switches SW61-SW63 are all coupled to the current source CS3 for receiving the driving current I₃.

The second end of the switch SW11, the second end of the switch SW31 and the second end of the switch SW51 are mutually coupled, the second end of the switch SW12, the second end of the switch SW32 and the second end of the switch SW52 are mutually coupled, and the second end of the switch SW13, the second end of the switch SW33 and the second end of the switch SW53 are mutually coupled.

Further, if a time interval is divided into a plurality of same periods, in the first period, the switch SW11, the switch SW21, the switch SW32, the switch SW42, the switch SW53 and the switch SW63 are turned on, and others are turned off. Now, the driving current I₁ is transmitted to the light emitting element string L1 through the turned on switches SW11 and SW21, the driving current I₂ is transmitted to the light emitting element string L2 through the turned on switches SW32 and SW42, and the driving current I₃ is transmitted to the light emitting element string L3 through the turned on switches SW53 and SW63.

In the second period, the switch SW12, the switch SW23, the switch SW33, the switch SW41, the switch SW51 and the switch SW62 are turned on, and others are turned off. Now, the driving current I₁ is transmitted to the light emitting element string L2 through the turned on switches SW33 and SW23, the driving current I₂ is transmitted to the light emitting element string L3 through the turned on switches SW51 and SW41, and the driving current I₃ is transmitted to the light emitting element string L1 through the turned on switches SW12 and SW62.

In the third period, the switch SW13, the switch SW22, the switch SW31, the switch SW43, the switch SW52 and the switch SW61 are turned on, and others are turned off. Now, the driving current I₁ is transmitted to the light emitting element string L3 through the turned on switches SW52 and SW22, the driving current I₂ is transmitted to the light emitting element string L1 through the turned on switches SW13 and SW43, and the driving current I₃ is transmitted to the light emitting element string L2 through the turned on switches SW31 and SW61. In this way, the driving currents I₁-I₃ are alternately transmitted to the light emitting element strings L1-L3.

According to the above descriptions, in the switch group GS1, one of the switches SW11-SW13 is turned on, and one of the switches SW21-SW23 is turned on. In the switch groups GS2 and GS3, switch operations are similar to that of the switch group GS1. Moreover, in the switch group GS1-GS3, the switches of the same positions (for example, the switch 11, the SW 31 and the switch 51) are not simultaneously turned on. Under the above conditions, if a switching sequence of turning on the switches SW11-SW13, SW31-SW33 and SW51-SW53 is inversed to a switching sequence of turning on the switches SW21-SW23, SW41-SW43 and SW61-SW63, the driving currents I₁₄₃ can be alternately transmitted to the light emitting element strings L1-L3.

Moreover, in other embodiments, the switches are unnecessarily to be sequentially switched for turning on, and only a part of the switches is probably turned on, though as long as the driving I₁-I₃ are alternately transmitted to the light emitting element strings L1-L3, it is considered to be within the scope of the invention. The turning on sequence of the switches can be deduced by those skilled in the art, which is not repeated herein.

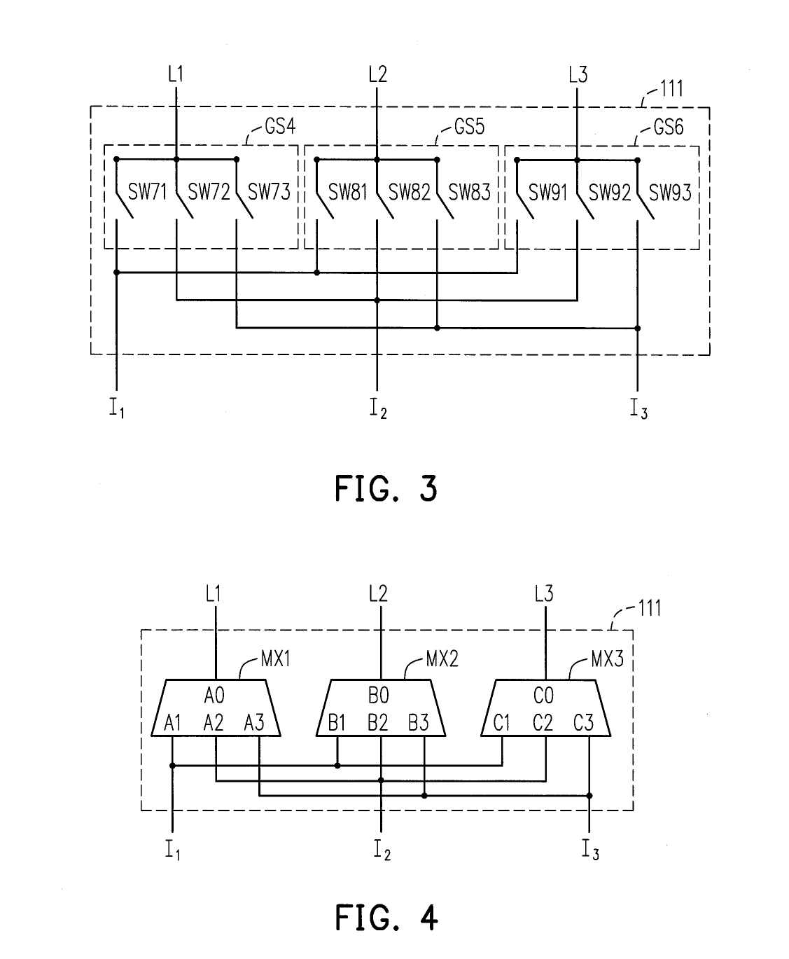

FIG. 3 is a circuit schematic diagram of the current switching unit 111 of FIG. 1 according to another embodiment of the invention. Referring to FIG. 3, in the present embodiment, the current switching unit 111 includes a plurality of second switch groups (three switch groups GS4-GS6 are taken as an example). The switch group GS4 includes a plurality of third switches (three switches SW71-SW73 are taken as an example), the switch group GS5 includes a plurality of third switches (three switches SW81-SW83 are taken as an example), and the switch group GS6 includes a plurality of third switches (three switches SW91-SW93 are taken as an example). Moreover, one of the switches SW71-SW73 of the switch group GS4 is turned on, one of the switches SW81-SW83 of the switch group GS5 is turned on, and one of the switches SW91-SW93 of the switch group GS6 is turned on. Moreover, the switches of the same positions (for example, the switches SW71, SW81 and SW91) in the switch groups GS4-GS6 are not simultaneously turned on.

According to the above descriptions, if the switches SW71-SW73, SW81-SW83 and SW91-SW93 switches the turned on switch in a same sequence, the driving currents I₁-I₃ are alternately transmitted to the light emitting element strings L1-L3. In other words, when the switch SW71, the switch SW82 and the switch SW93 are turned on, the driving current I₁ is transmitted to the light emitting element string L1, the driving current I₂ is transmitted to the light emitting element string L2, and the driving current I₃ is transmitted to the light emitting element string L3. When the switch SW73, the switch SW81 and the switch SW92 are turned on, the driving current I₁ is transmitted to the light emitting element string L2, the driving current I₂ is transmitted to the light emitting element string L3, and the driving current I₃ is transmitted to the light emitting element string L1. When the switch SW72, the switch SW83 and the switch SW91 are turned on, the driving current I₁ is transmitted to the light emitting element string L3, the driving current I₂ is transmitted to the light emitting element string L1, and the driving current I₃ is transmitted to the light emitting element string L2.

FIG. 4 is circuit schematic diagram of the current switching unit 111 of FIG. 1 according to still another embodiment of the invention. Referring to FIG. 4, in the present embodiment, the current switching unit 111 includes a plurality of multiplexers (three multiplexers MX1-MX3 are taken as an example). In the present embodiment, an output terminal A0 of the multiplexer MX1 is coupled to the light emitting element string L1, an input terminal A1 of the multiplexer MX1 is coupled to the current source CS1 for receiving the driving current I_{I}, an input terminal A2 of the multiplexer MX1 is coupled to the current source CS2 for receiving the driving current I₂, and an input terminal A3 of the multiplexer MX1 is coupled to the current source CS3 for receiving the current source I₃. An output terminal B0 of the multiplexer MX2 is coupled to the light emitting element string L2, an input terminal B1 of the multiplexer MX2 is coupled to the current source CS1 for receiving the driving current I_{I}, an input terminal B2 of the multiplexer MX2 is coupled to the current source CS2 for receiving the driving current I₂, and an input terminal B3 of the multiplexer MX2 is coupled to the current source CS3 for receiving the current source I₃.

An output terminal C0 of the multiplexer MX3 is coupled to the light emitting element string L3, an input terminal C1 of the multiplexer MX3 is coupled to the current source CS1 for receiving the driving current I_{I}, an input terminal C2 of the multiplexer MX3 is coupled to the current source CS2 for receiving the driving current I₂, and an input terminal C3 of the multiplexer MX3 is coupled to the current source CS3 for receiving the current source I₃. In a same period, the multiplexers MX1-MX3 select different current sources (for example, CS1, CS2 and CS3) for respectively transmitting the driving currents I₁-I₃ to the light emitting element strings L1-L3, and the multiplexers MX1-MX3 switch the selected current sources (for example, CS1, CS2 and CS3) by timing.

In summary, in the backlight module and the driving circuit of the invention, the current switching unit is used to alternately transmit the driving currents to a plurality of the light emitting element strings. In this way, an average current of each of the light emitting element stings is the same, so that the light emitting brightness of the light emitting element strings are similar or the same.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A driving circuit, adapted to drive a plurality of light emitting element strings, the driving circuit comprising:
a plurality of current sources, for respectively providing a plurality of driving currents; and
a current switching unit, coupled between the light emitting element strings and the current sources, for respectively transmitting the driving currents to the light emitting element strings, and switching the driving currents received by the light emitting element strings by timing, wherein time for each of the light emitting element strings receiving the driving currents is the same.

2. The driving circuit as claimed in claim 1, wherein the current switching unit comprises:
a plurality of first switch groups, each of the first switch groups comprising:
n first switches, having first ends respectively coupled the corresponding light emitting element string, wherein n is a positive integer; and
n second switches, having first ends respectively coupled to second ends of the first switches, and second ends respectively coupled to the corresponding current source,
wherein a second end of an i-th first switch of each of the first switch groups is coupled to a second end of an i-th first switch of the adjacent first switch group, i is a positive integer and 1≦i≦n, one of the first switches and one of the second switches are turned on, and the turned on first switch and the turned on second switch are switched by timing, and in different first switch groups, the turned on first switch and the turned on second switch correspond to different positions.

3. The driving circuit as claimed in claim 2, wherein a switching sequence of turning on the first switches is inversed to a switching sequence of turning on the second switches.

4. The driving circuit as claimed in claim 1, wherein the current switching unit comprises:
a plurality of second switch groups, and each of the second switch groups comprising:
a plurality of third switches, having first ends respectively coupled to the corresponding light emitting element string, and second ends respectively coupled to the current sources,
wherein one of the third switches is turned on, and the turned on third switch is switched by timing, and in different second switch groups, the turned on third switch is coupled to the different current source.

5. The driving circuit as claimed in claim 1, wherein the current switching unit comprises:
a plurality of multiplexers, each having a plurality of input terminals and an output terminal, wherein the output terminal of each of the multiplexers is coupled to the corresponding light emitting element string, and the input terminals of each of the multiplexers are respectively coupled to the current sources, each of the multiplexers switches the selected current source by timing, and different multiplexers select different current sources.

6. The driving circuit as claimed in claim 1, further comprising:
an adjustment unit, coupled to the light emitting element strings and the current sources, for adjusting the driving currents according to currents of the light emitting element strings.

7. The driving circuit as claimed in claim 1, further comprising:
a plurality of switches, respectively coupled between the current sources and a ground voltage; and
a control unit, coupled to the switches, for controlling conduction states of the switches according to a pulse width modulation signal, so as to control the current sources to whether or not provide the driving currents to the light emitting element strings.

8. The driving circuit as claimed in claim 7, wherein the control unit comprises:
a buffer, having an input terminal receiving the pulse width modulation signal, and an output terminal coupled to the switches; and
a resistor, coupled between the input terminal of the buffer and the ground voltage.

9. A backlight module, comprising:
a plurality of light emitting element strings; and
a driving circuit, comprising:
a plurality of current sources, for respectively providing a plurality of driving currents; and
a current switching unit, coupled between the light emitting element strings and the current sources, for transmitting the driving currents to the light emitting element strings, and switching the driving currents received by the light emitting element strings by timing, wherein time for each of the light emitting element strings receiving the driving currents is the same.

10. The backlight module as claimed in claim 9, wherein the current switching unit comprises:
a plurality of first switch groups, each of the first switch groups comprising:
n first switches, having first ends respectively coupled the corresponding light emitting element string, wherein n is a positive integer; and
n second switches, having first ends respectively coupled to second ends of the first switches, and second ends respectively coupled to the corresponding current source,
wherein a second end of an i-th first switch of each of the first switch groups is coupled to a second end of an i-th first switch of the adjacent first switch group, i is a positive integer and 1≦i≦n, one of the first switches and one of the second switches are turned on, and the turned on first switch and the turned on second switch are switched by timing, and in different first switch groups, the turned on first switch and the turned on second switch correspond to different positions.

11. The backlight module as claimed in claim 10, wherein a switching sequence of turning on the first switches is inversed to a switching sequence of turning on the second switches.

12. The backlight module as claimed in claim 9, wherein the current switching unit comprises:
a plurality of second switch groups, and each of the second switch groups comprising:
a plurality of third switches, having first ends respectively coupled to the corresponding light emitting element string, and second ends respectively coupled to the current sources,
wherein one of the third switches is turned on, and the turned on third switch is switched by timing, and in different second switch groups, the turned on third switch is coupled to the different current source.

13. The backlight module as claimed in claim 9, wherein the current switching unit comprises:
a plurality of multiplexers, each having a plurality of input terminals and an output terminal, wherein the output terminal of each of the multiplexers is coupled to the corresponding light emitting element string, and the input terminals of each of the multiplexers are respectively coupled to the current sources, each of the multiplexers switches the selected current source by timing, and different multiplexers select different current sources.

14. The backlight module as claimed in claim 9, further comprising:
an adjustment unit, coupled to the light emitting element strings and the current sources, for adjusting the driving currents according to currents of the light emitting element strings.

15. The backlight module as claimed in claim 9, further comprising:
a plurality of switches, respectively coupled between the current sources and a ground voltage; and
a control unit, coupled to the switches, for controlling conduction states of the switches according to a pulse width modulation signal, so as to control the current sources to whether or not provide the driving currents to the light emitting element strings.

16. The backlight module as claimed in claim 15, wherein the control unit comprises:
a buffer, having an input terminal receiving the pulse width modulation signal, and an output terminal coupled to the switches; and
a resistor, coupled between the input terminal of the buffer and the ground voltage.

17. The backlight module as claimed in claim 9, wherein the light emitting element strings are respectively a light emitting diode string.
